(19) United States
(12) Patent Application Publication
(10) Pub. No.: US 2026/0050267 A1
(43) Pub. Date: Feb. 19, 2026

(54) PATH PLANNING METHOD, AUTONOMOUS MOBILE DEVICE, AND STORAGE MEDIUM

(71) Applicant: SHENZHEN MAMMOTION INNOVATION CO., LIMITED, Shenzhen (CN)

(72) Inventors: Jidong WEI, Shenzhen (CN); Zijun HE, Shenzhen (CN)

(73) Assignee: SHENZHEN MAMMOTION INNOVATION CO., LIMITED, Shenzhen (CN)

(21) Appl. No.: 19/298,158

(22) Filed: Aug. 12, 2025

(30) Foreign Application Priority Data
Aug. 14, 2024 (CN) 202411120036.3

(51) Int. Cl. G05D 1/648

(52) U.S. Cl. CPC G05D 1/648

(57) ABSTRACT

Embodiments of the present disclosure provide a path planning method, autonomous mobile device, and storage medium. The method comprises: acquiring boundary maps corresponding to a plurality of work areas of the autonomous mobile device; merging the boundary maps to obtain a operational map; determining a movement path from a first position to a second position based on the first position and the second position in the operational map. the disclosure can improve path planning performance in scenarios where mobile devices are present in plurality of work areas with partial overlap.

### CROSS-REFERENCE TO RELATED APPLICATION

The present application claims the benefit of and priority to Chinese Patent Application No. 202411120036.3, filed with the China National Intellectual Property Administration on Aug. 14, 2024 and entitled “PATH PLANNING METHOD, AUTONOMOUS MOBILE DEVICE, AND STORAGE MEDIUM”, the disclosure of which is incorporated herein by reference in its entirety.

### TECHNICAL FIELD

This application relates to the technical field of autonomous mobile devices, and more particularly, to a path planning method, an autonomous mobile device, and a storage medium.

### BACKGROUND

With the continuous advancement of technology and the rapid development of artificial intelligence, the use of autonomous mobile devices (e.g., lawn mowers, cleaning robots, patrol robots, etc.) to perform operations can significantly improve work efficiency.

In related technologies, autonomous mobile devices typically perform tasks based on pre-planned working paths. However, when unexpected events occur—such as low battery—that require the autonomous mobile device to interrupt its current task and travel from its current location to a target location (e.g., where a charging device is located), it must promptly plan a movement path and navigate along that path to reach the target location in order to ensure continued operation.

However, existing methods often require multiple rounds of searching and path combination to determine a locally optimal movement path, resulting in suboptimal path planning performance.

### SUMMARY

In view of the above, it is necessary to provide a path planning method, a self-moving device, and a storage medium that can solve the technical problem of poor mobile path planning performance.

According to a first aspect, an embodiment of the present disclosure provides a path planning method, performed by an autonomous mobile device, comprising,
acquiring boundary maps corresponding to a plurality of work areas of the autonomous mobile device;
merging the boundary maps to obtain a operational map;
determining a movement path from a first position to a second position based on the first position and the second position in the operational map.

Alternatively, in the path planning method provided by the embodiments of the present disclosure, the acquiring boundary maps corresponding to the plurality of working areas of the autonomous mobile device comprises:
acquiring a plurality of boundary contours in response to a user operation instructions;
determining the boundary maps corresponding to the plurality of work areas of the autonomous mobile device based on the plurality of work areas contours, wherein at least two of the work areas overlap.

Alternatively, in the path planning method provided by the embodiments of the present disclosure, determining the movement path from the first position to the second position based on the operational map comprises:
determining the shortest path from the first position to the second position as the movement path based on the operational map.

Alternatively, in the path planning method provided by the embodiments of the present disclosure, the determining the movement path from the first position to the second position comprises: determining a first path from the first position to a boundary of the operational map; determining a second path from the boundary to the second position; and determining the movement path based on the first path and the second path.

Alternatively, in the path planning method provided by the embodiments of the present disclosure, the boundary of the operational map comprises a plurality of boundary position points, and determining the first path and the second path comprises: determining, from the plurality of boundary position points, a target boundary position point corresponding to a minimal working distance from the first position to the boundary of the operational map; determining a path from the first position to the target boundary position point as the first path; and determining a shortest path from the target boundary position point to the second position as the second path.

Alternatively, in the path planning method provided by the embodiments of the present disclosure, determining the movement path based on the first path and the second path comprises: moving from the first position to the target boundary position point according to the first path; and moving from the target boundary position point to the second position according to the second path.

Alternatively, in the path planning method provided by the embodiments of the present disclosure, determining an avoidance path corresponding to obstacles based on the operational map, when the movement path includes the obstacles; and adjusting the movement path based on the avoidance path.

Alternatively, in the path planning method provided by the embodiments of the present disclosure, after determining the avoidance path corresponding to the obstacle based on the operational map, the method further comprises: determining an avoidance endpoint corresponding to the avoidance path; when the avoidance endpoint is not on the movement path, determining a shortest path from the avoidance endpoint to the second position as an adjusted movement path based on the operational map.

According to a second aspect, an embodiment of the present disclosure provides a path planning apparatus, applied to an autonomous mobile device, comprising:
a map determination unit configured to obtain boundary maps corresponding to a plurality of working areas of the autonomous mobile device;
a map merging unit configured to merge the boundary maps to generate a operational map; and
a path planning unit configured to determine a movement path from a first position to a second position on the operational map, based on the first position and second position.

According to a third aspect, an embodiment of the present disclosure provides An autonomous mobile device, comprising: a memory, a processor, and a computer program stored on the memory and executable by the processor, wherein when executed, the processor implements the path planning method according to the above method.

According to a fourth aspect, an embodiment of the present disclosure provides An embodiment of the present disclosure provides a computer-readable storage medium, wherein the computer-readable storage medium stores a computer program, and when executed by a processor of an autonomous mobile device, the computer program implements any one of the path planning methods described above.

In the charging path planning method of the present embodiment, boundary maps corresponding to a plurality of working areas of the autonomous mobile device are obtained; the boundary maps are merged to generate a operational map; and based on the first position and the second position on the operational map, a movement path from the first position to the second position is determined. By merging a plurality of work areas into a single operational map, the method avoids treating each working area as an independent map and planning paths within each independent map, which results in a large number of path planning operations. This improves the efficiency of path planning. Moreover, by planning the movement path from the first position to the second position based on the operational map, the movement path can achieve a global optimum, thereby enhancing the accuracy of path planning.

### BRIEF DESCRIPTION OF DRAWINGS

FIG. 1 is a schematic diagram of movement path planning in the related art provided in one embodiment of the present disclosure.

FIG. 2 is a schematic diagram of movement path planning in the related art provided in one embodiment of the present disclosure.

FIG. 3 is a flowchart of the path planning method provided in one embodiment of the present disclosure.

FIG. 4 is a schematic diagram of the operational map provided in one embodiment of the present disclosure.

FIG. 5 is a schematic diagram of the movement path provided in one embodiment of the present disclosure.

FIG. 6 is a flow diagram illustrating a method for determining a movement path provided in one embodiment of the present disclosure.

FIG. 7 is a schematic diagram of the movement path provided in one embodiment of the present disclosure.

FIG. 8 is a flow diagram illustrating a method for determining an obstacle avoidance path provided in one embodiment of the present disclosure.

FIG. 9 is a structural schematic diagram of the path planning device provided in one embodiment of the present disclosure.

FIG. 10 is a structural schematic diagram of the autonomous mobile device provided in one embodiment of the present disclosure.

### DETAILED DESCRIPTION OF THE EMBODIMENTS

To further illustrate the objectives, technical solutions, and advantages of the present disclosure, the following detailed description is provided with reference to the accompanying drawings and specific embodiments.

It should be noted that the term “at least one” as used herein refers to one or more, and “a plurality of” refers to two or more. The term “and/or” used to describe relationships between associated elements means any and all combinations of one or more of the associated elements. For example, “A and/or B” may refer to: A alone, A and B together, or B alone, wherein A and B may each be singular or plural. In addition, terms such as “first,” “second,” “third,” “fourth,” etc. (if present) in the specification, claims, or drawings of the present disclosure are used solely to distinguish between similar elements or components, and are not intended to indicate any particular order or sequence unless otherwise explicitly stated.

In the embodiments of the present disclosure, the terms “exemplary” or “for example” are used to indicate examples, illustrations, or explanations. Any embodiment or design described as “exemplary” or introduced with “for example” should not be construed as being preferred or having advantages over other embodiments or designs. Rather, the use of such terms is intended solely to present associated concepts in a specific and concrete manner.

In the related art, autonomous mobile devices typically perform operational tasks based on a pre-planned working path. When an unexpected situations occurs that requires the autonomous mobile device to stop the current task and travel from its current location to a target location, the device must promptly plan a travel path and follow the planned path to reach the target location in order to ensure proper operation. The unexpected situations may include, but are not limited to, low battery levels, device malfunction, or the need for cleaning. The target location may include, but is not limited to, the location of a charging station, maintenance station, or cleaning station. Since such equipment (e.g., charging, maintenance, or cleaning equipment) is typically positioned near the region boundary of the operational map, the autonomous mobile device may span across a plurality of work areas when moving to these locations. Furthermore, as it is generally difficult for the autonomous mobile device to fully cover the edges of each work areas during operation—or due to complex terrain such as irregular area edges or numerous obstacles when operates in different areas, overlapping areas are often configured to ensure completeness and uniformity of the lawn or other operational environments. Therefore, when the autonomous mobile device moves toward such equipment, the travel path frequently involves crossing a plurality of work areas with partial overlaps between them.

However, existing path planning methods generally perform well when the current position and the target position of the autonomous mobile device are located within the same single work area. In scenarios involving a plurality of work areas with partial overlaps, these methods suffer from low path planning efficiency and fail to obtain a globally shortest path, resulting in poor path planning performance. For example, consider the scenario where an autonomous mobile device needs to move promptly to a charging device to replenish its battery power due to low battery. When planning a movement path from the current position to the charging device, the autonomous mobile device may generate either a boundary-following path or a non-boundary path. The boundary-following path refers to a path along the boundary of a work area, whereas the non-boundary path refers to a path crossing through the plurality of the work areas. The embodiments of the present disclosure by taking these two types of paths-boundary-following paths and non-boundary paths as examples to illustrate the existing technology.

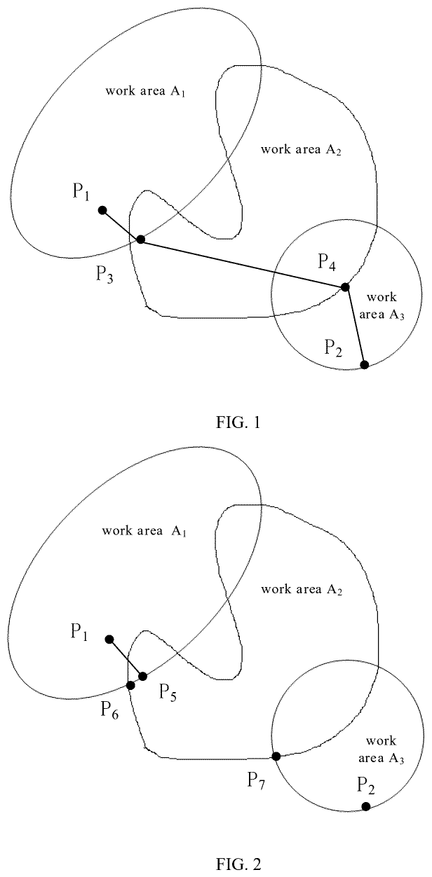

As shown in FIG. 1, which illustrates a schematic diagram of path planning in related art provided by one embodiment of the present disclosure, and as shown in FIG. 2, which illustrates another schematic diagram of path planning in related art provided by another embodiment of the present disclosure, the work areas include three distinct regions: work area A1, work area A2, and work area A3. The autonomous mobile device is located at position P1 in work area A1, and the charging device is located at position P2 in work area A3. There are two overlapping regions between work area A1 and work area A2, and one overlapping region between work area A2 and work area A3. In the related art, as shown in FIG. 1, to plan the shortest path from position P1 to position P2, the autonomous mobile device must treat each work area as an independent map and perform path planning separately within each independent map. For example, a path is planned from position P1 to position P3 within work area A1; another path is planned from position P3 to position P4 within work area A2; and a further path is planned from position P4 to position P2 within work area A3. In this manner, three separate shortest path planning operations are required across three independent maps in order to obtain a single composite non-boundary path.

As shown in FIG. 2, in order to plan an boundary-following path from position P1 to position P2, the autonomous mobile device need to perform 30 path planning operations to generate 30 boundary-following paths. The shortest path among these 30 boundary-following paths is then selected as the movement path. For example, the movement path in FIG. 2 includes the path from position P1 to position P5, the path from position P5 to the overlapping point P6, the edge-following path from position P6 to position P7, and the boundary-following path from position P7 to position P2. In summary, existing technologies are inefficient in planning boundary-following paths and non-boundary-following paths in scenarios involving a plurality of work areas with partial overlaps, and the resulting movement paths are local shortest paths rather than global shortest paths.

In view of the foregoing, there is a need to provide a path planning method, an autonomous mobile device, and a computer-readable storage medium, which can improve the path planning performance of the autonomous mobile device in scenarios involving a plurality of partially overlapping work areas.

The path planning method provided in the embodiments of the present disclosure may be applied to one or more autonomous mobile devices. The autonomous mobile devices may include, but are not limited to, lawn mowers, cleaning machines, or patrolling machines. In other embodiments, the path planning method provided herein may also be applied to one or more electronic devices. These electronic devices may be used to control the movement of autonomous mobile devices, and may include, for example, computers, tablets, mobile phones, servers, cloud servers, personal digital assistants (PDAs), game consoles, Internet Protocol Televisions (IPTVs), smart wearable devices, and the like. The present disclosure does not impose limitations on the types of autonomous mobile devices or electronic devices. For illustrative purposes, the embodiments are described with reference to application scenarios involving autonomous mobile devices.

To more clearly illustrate the path planning method provided in the embodiments of the present disclosure, specific embodiments will be described in detail below to explain the technical solutions of the present disclosure. It should be noted that the following specific embodiments may be combined with one another, and for the sake of brevity, identical or similar concepts or processes may not be repeatedly described in some embodiments.

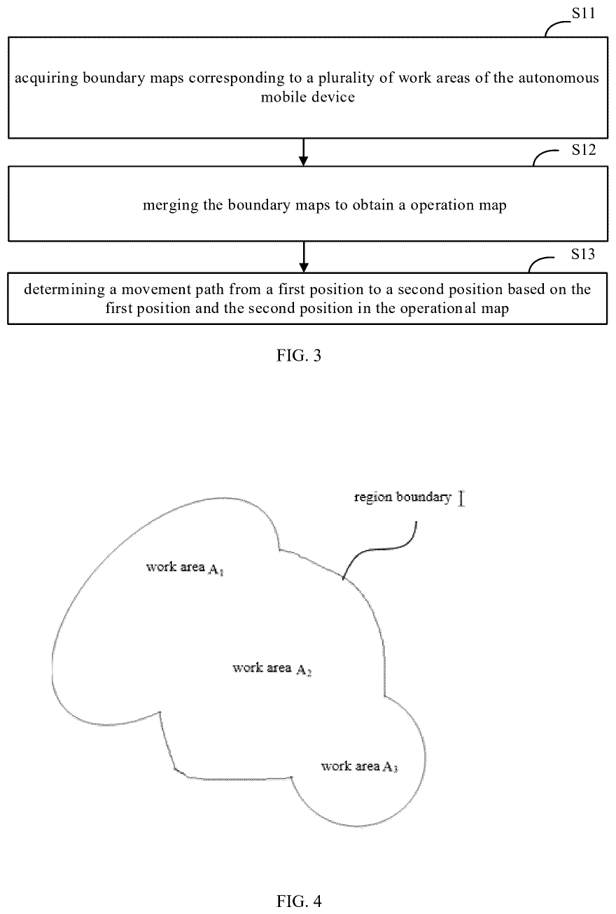

As shown in FIG. 3, a flowchart of a path planning method provided in an embodiment of the present disclosure is illustrated. The order of the steps in the flowchart may be adjusted based on actual requirements, and certain steps may be omitted depending on different needs. The method is applicable to a self-moving device (e.g., a lawn mower, a cleaning robot, or a patrolling robot).

S11, Acquiring boundary maps corresponding to a plurality of work areas of the autonomous mobile device.

In at least one embodiment of the present disclosure, during operation, the autonomous mobile device may encounter unexpected situations. These situations may include, but are not limited to, low battery levels, device malfunction, or the need for cleaning, or the need to clear objects (e.g., fallen leaves, garbage, etc.) from the device's storage compartment. To address such unexpected situations, designated locations within the work areas may be equipped with pre-set devices, The pre-set devices may include, but are not limited to, charging equipment, maintenance equipment, and cleaning equipment. For example, when the battery level of the autonomous mobile device falls below a preset power threshold, the autonomous mobile device will promptly move to the charging equipment to recharge. The preset power threshold can be configured as needed, and the present disclosure imposes no limitation on the specific value of the threshold. Another example is that when the autonomous mobile device encounters a malfunction, the autonomous mobile device will promptly move to the maintenance equipment for maintenance. Another example is that when the autonomous mobile device requires cleaning, the device will move to the cleaning equipment for cleaning. When the autonomous mobile device encounters the aforementioned unexpected situations, it can perform the step of acquiring boundary maps corresponding to a plurality of work areas. In other embodiments, the autonomous mobile device may support human-machine interaction, whereby a user may input an operation command via various input methods such as a keyboard, mouse, remote control, touchpad, or voice-control device. In further embodiments, the autonomous mobile device may be communicatively connected to a user terminal. The user terminal may include, but is not limited to, any type of electronic device that allows user interaction through keyboard, mouse, remote control, touchpad, or voice control—for example, a personal computer, tablet, smartphone, or digital camera. The user terminal may also be a control device such as a remote controller. The user may send operation commands to the autonomous mobile device via the user terminal. In one embodiment, the operation commands may include, but are not limited to, a charging command, fault handling command, or cleaning command. The autonomous mobile device, in response to the operation command, may execute the step of acquiring boundary maps corresponding to the plurality of work areas.

In some embodiments, the boundary maps corresponding to a plurality of work areas of the autonomous mobile device may be obtained by parsing a user operation instruction. The user operation instruction is configured to indicate the work areas to be operated by the autonomous mobile device. The work areas may comprise: the work area in which the autonomous mobile device is currently located, the work area in which the pre-set device is located, and one or more work areas to be traversed between the autonomous mobile device and the pre-set device. The number of work areas is greater than or equal to two, and at least two of the plurality of work areas partially overlap. In the plurality of work areas, the operation parameters of each work area may be the same or different. No limitations are imposed herein. The operation parameters may comprise, but are not limited to, operation height, operation angle, operation spacing, and may further comprise path generation modes, such as a zigzag-shaped path or a loop-shaped path. Continuing the above embodiment, the work areas include work area A1, work area A2, and work area A3. The autonomous mobile device is located at position P1 in work area A1, and the charging device is located at position P2 in work area A3. In order to move from position P1 to position P2, the autonomous mobile device needs to cross work area A2.

In some embodiments, the boundary maps may be a Global Positioning System (GPS) map and may include a two-dimensional or three-dimensional scene map. In practical applications, no limitations are imposed on the form of the boundary maps.

S12, Merging the boundary maps to obtain a operational map.

In at least one embodiment of the present disclosure, at least two of the plurality of work areas partially overlap. Based on this, the overlapping map regions among the plurality of work areas are merged to generate an operational map.

In some embodiments, merging the boundary maps to generate the operational map may comprises: determining the boundary contours corresponding to the boundary maps; identifying the overlapping map regions based on the boundary contours; and merging the overlapping map regions to obtain the operational map.

In some embodiments, the region information contained within the boundary maps includes, but is not limited to, the boundary contours of the work area, the terrain of the work area, obstacles, vegetation density, and other information. By parsing the boundary maps, the corresponding boundary contour scan be determined. The boundary contours refers to the external boundary of the work area and may be a set of coordinate points. Parsing the boundary contours enable determination of information such as the perimeter and shape of the work area.

In some embodiments, at least two of the plurality of work areas partially overlap. If the boundary contour of one work area intersects with that of another work area, it is determined that these two work areas are partially overlapping. The region formed by the intersecting boundary contours is defined as the overlapping map region.

In some embodiments, merging the map regions to obtain the operational map may include: removing the contour lines of the overlapping parts of the two work areas (i.e., the contour lines corresponding to the overlapping map regions) using visual processing algorithms (e.g., OpenCV), and obtaining a merged boundary contour. A merged boundary map (region boundary) corresponding to the merged boundary contour is then used as the operational map.

For example, as shown in FIG. 4, a schematic diagram of an operational map is provided in an embodiment of the present disclosure. Continuing from the above embodiment, there exist work area A1, work area A2, and work area A3, where work area A2 partially overlaps with work area A1 at two locations, and work area A3 partially overlaps with work area A2 at one location. The merging process comprises combining work area A1, work area A2, and work area A3, that is, removing the contour lines of the overlapping portions between any two work areas to obtain a merged boundary contour, referred to as region boundary I. The boundary maps corresponding to region boundary I is used as the operational map.

S13, Determining a movement path from a first position to a second position based on the first position and the second position.

In at least one embodiment of the present disclosure, the first position and the second position may be preconfigured based on actual requirements. For example, the first position may correspond to the location of the autonomous mobile device within the operational map, and the second position may correspond to the location of the pre-set device within the operational map.

In some embodiments, determining the first work area in which the autonomous mobile device is located, as well as the position information of the autonomous mobile device within the first work area, enables the identification of the first position of the autonomous mobile device in the operational map. The autonomous mobile device may obtain its current location through various means. For example, the autonomous mobile device may determine its current position using Real-Time Kinematic (RTK) positioning technology.

In some embodiments, determining the second work area in which the pre-set device is located, as well as the position information of the pre-set device within the second work area, enables the identification of the second position of the pre-set device in the operational map. The pre-set device may be located at or near the region boundary of the operational map. The present embodiment is illustrated by way of example with the pre-set device being located at the region boundary of the operational map.

In at least one embodiment of the present disclosure, the movement path may include a boundary-following path and a non-boundary-following path. The boundary-following path may refer to a path along the region boundary of the operational map from the first position to the second position, followed by the autonomous mobile device, which helps avoid damaging the already-trimmed operation areas.

The non-boundary-following path may refer to a path that traverses a plurality of work areas between the first position and the second position, allowing the autonomous mobile device to quickly reach the second position to promptly address emergencies. In some embodiments, the boundary-following path or the non-boundary-following path may be selected based on actual operational requirements. For example, if the autonomous mobile device has low battery power and cannot support long-distance movement, a non-boundary-following path can be generated to enable the device to reach the second position quickly. Conversely, if the work areas to be crossed have already been trimmed, a boundary-following path may be generated to avoid damaging the finished work areas.

In the charging path planning method of the present embodiment, by merging the plurality of the work areas to a operational map, the method avoids treating each work area as an independent map and planning paths in the corresponding independent maps for each work area, thereby addressing the issue of excessive path planning iterations and improving path planning efficiency. Additionally, by planning the movement path from the first position to the second position based on the operational map, the method ensures that the movement path achieves global optimality, thereby enhancing the accuracy of path planning. In addition, by merging multiple operation areas into operational map, the present embodiment enables movement path planning to be accomplished through a single map switching and map generation process, thereby avoiding redundant operations related to repeated map switching and generation, and further improving the efficiency of movement path planning.

In at least one embodiment of the present disclosure, acquiring the boundary maps corresponding to a plurality work areas of the autonomous mobile device comprises: in response to a user operation instructions, determining a plurality of boundary contours; and determining the boundary map corresponding to the multiple work areas of the mobile device based on the multiple boundary contours, wherein at least two of the plurality of work areas overlap.

In some embodiment, the work area may be drawn by the user according to actual needs. for example, the user may obtain the overall boundary map of the plurality of work areas through a pre-set application, and then draw a plurality of boundary contours within the overall boundary map, each boundary contour representing one work area, thereby obtaining the plurality of the work areas and their boundary maps. The overall boundary map of the operation areas may be a Global Positioning System (GPS) map, which may include a two-dimensional or three-dimensional scene map. In practical applications, no limitations are imposed on the form of the overall boundary map. Furthermore, considering that the movement path of the autonomous mobile device may have difficulty covering the edges of the work areas, or that the autonomous mobile device may encounter irregular area boundaries, numerous obstacles, or other complex terrain when operating in different regions, overlapping between at least two work areas is adopted to ensure effective operation.

In this embodiment, the boundary maps of the plurality work areas are determined in response to the user operation instructions, enabling the autonomous mobile device to operate in a manner that meets the user's requirements.

In at least one embodiment of the present disclosure, it is also possible to construct a minimal blank map containing the plurality of work areas based on their respective location information, and perform merging processing of the operation areas on this blank map.

In at least one embodiment of the present application, a minimal blank map comprising a plurality of work areas may also constructed based on the position information of the plurality of the work area. In some embodiment, to ensure that the boundary contours of all the plurality of work areas can be completely mapped onto the blank map, determine the blank map corresponding to the plurality of work areas based on the position information of each work area; for example, using the coordinates of the work areas in the world coordinate system, the horizontal coordinates in the position information of each work area are determined to obtain multiple horizontal coordinates, The maximum horizontal coordinate and minimum horizontal coordinate are then identified, and the difference between the maximum horizontal coordinate and minimum horizontal coordinate is used as the map length. using the coordinates of the work areas in the world coordinate system as an example, the vertical coordinates in the position information of each work area are determined to obtain multiple vertical coordinates, The maximum vertical coordinate and minimum vertical coordinate are identified from the multiple vertical coordinates, and the difference between the maximum vertical coordinate and minimum vertical coordinate is used as the map width. Based on the map length and map width, the blank map with a regular shape and an area greater than or equal to the map length multiplied by the map width can be constructed. In some embodiments, the boundary maps corresponding to multiple work areas from the mobile device are mapped onto the blank map, and merging processing is performed on the blank map. In some embodiments, the boundary maps corresponding to the plurality of areas of the autonomous mobile device are mapped onto the blank map, and the merging processing is performed on the blank map accordingly.

In at least one embodiment of the present application, when the movement path is a non-boundary-following path, determining the movement path from the first position to the second position comprises: Determining the shortest path from the first position to the second position as the movement path based on the operational map, Since a straight path is the shortest path between two points, the autonomous mobile device may determine the straight-line path from the first position to the second position within the operational map as the movement path, and use this path as the non-boundary-following path.

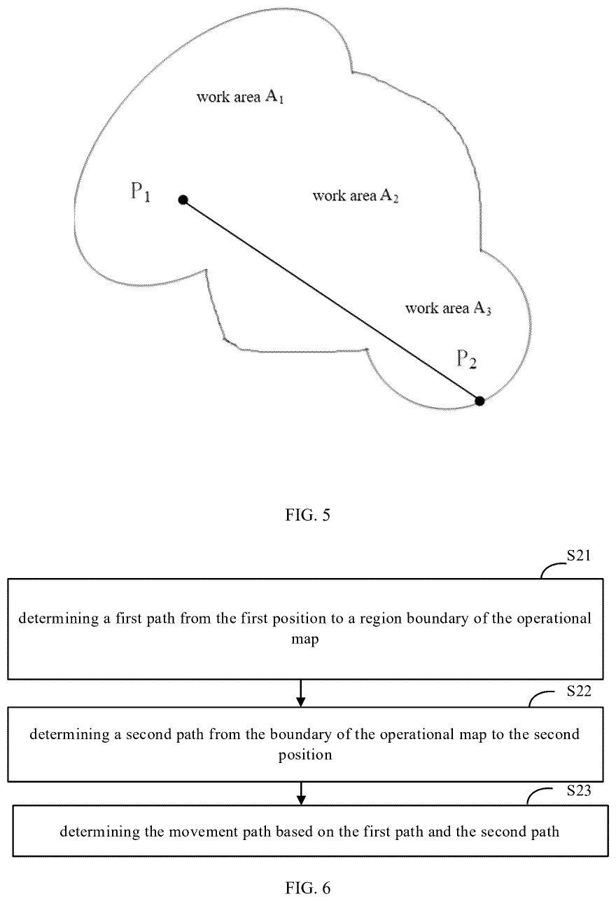

For example, as shown in FIG. 5, a schematic diagram of a movement path provided in one embodiment of the present disclosure is illustrated. The operational map includes a merged region boundary I, which results from merging the boundary contours of work area A1, work area A2, and work area A3. Position P1 represents the position of the autonomous mobile device within the operational map (i.e., the first position), and Position P2 represents the position of the pre-set device within the operational map (i.e., the second position), Position P2 is located on the region boundary I.

A straight-line path from position P1 to position P2 is determined as the movement path of the autonomous mobile device. Based on this movement path, the autonomous mobile device can move from Position P1 to Position P2.

In at least one embodiment of the present disclosure, when the movement path is along an boundary-following path, the movement path is planned in conjunction with the regional boundaries of the operational map. FIG. 6 is a flowchart illustrating the movement path determination method provided by an embodiment of the present disclosure, which is applied to an autonomous device. As shown in FIG. 6, the method comprises the following steps:

S21, determining a first path from the first position to a region boundary of the operational map.

In at least one embodiment of the present disclosure, when the movement path is the boundary-following path, the movement path may include a first path from the first position to the region boundary of the operational map, and a second path from the region boundary of the operational map to the second position. The first path may be the shortest path from the autonomous mobile device's first position to the region boundary of the operational map. The method for determining the first path may comprises: determining, from a plurality of boundary position points, a target boundary position point corresponding to a minimal working distance from the first position to the region boundary of the operational map; determining a path from the first position to the target boundary position point as the first path. For example, the region boundary of the operational map comprises a plurality of boundary position points, each of which has a corresponding boundary tangent, The autonomous mobile device may determine the distance from the first position to the tangent of each boundary position point using a point-to-line distance formula, The boundary position point with the shortest distance is selected as the target boundary position point. Since a straight line path is the shortest between two points, the autonomous mobile device may determine the straight-line path from the first position to the target boundary position point as the first path based on the operational map. In this embodiment, by planning a first path corresponding to the shortest operational distance from the first position to the boundary, the distance the autonomous mobile device must travel from the first position to the regional boundary is reduced, thereby minimizing the impact on the work environment such as the lawn.

S22, determining a second path from the region boundary of the operational map to the second position.

In at least one embodiment of the present disclosure, the second path may be the shortest boundary-following path from the target boundary position point to the second position along the region boundary of the operational map. The method for determining the second path may comprises:
determining the shortest path from the target boundary position point to the second position along the region boundary as the second path.

For example, after determining the target boundary position point, two boundary-following paths from the target boundary position point to the second position may be determined in two directions (i.e., clockwise and counterclockwise). Among the two boundary-following paths, the shorter one is selected as the second path.

S23, determining the movement path based on the first path and the second path.

In at least one embodiment of the present disclosure, after planning the first path and the second path, the first path and the second path are used as the movement path. For example, the autonomous mobile device may move from the first position to the target boundary position point along the first path, and then move from the target boundary position point to the second position along the second path.

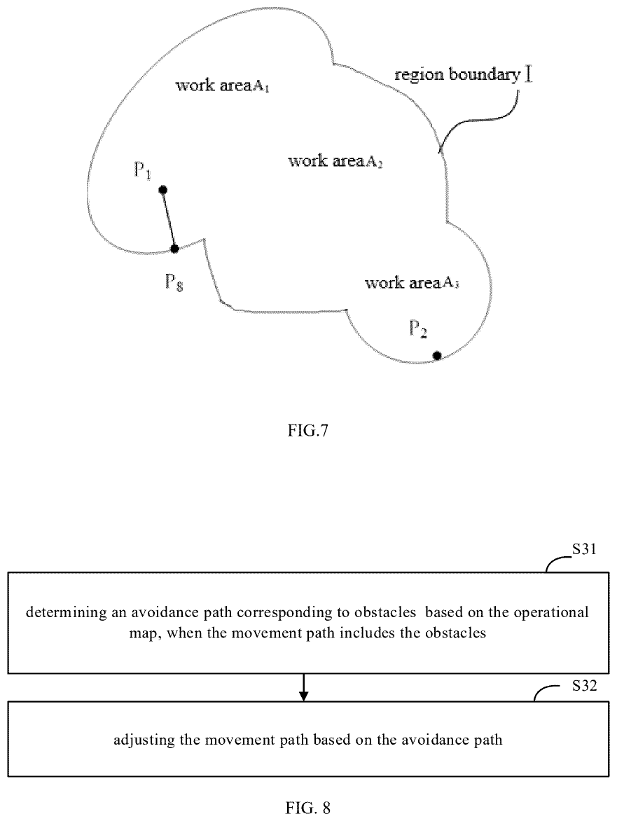

For example, as illustrated in FIG. 7, a schematic diagram of the movement path is provided according to another embodiment of the present disclosure. The operational map includes a region boundary I, which is obtained by merging the boundary contours of work area A1, work area A2, and work area A3. Position P1 represents the location of the autonomous mobile device in the operational map (i.e., the first position), and position P2 represents the location of the preset device in the operational map (i.e., the second position). Position P8 is the target boundary position point on the region boundary that has the shortest distance to P1. The straight-line path from P1 to P8 is determined as the first path, and the boundary-following path from P8 to P2 is determined as the second path. The first path and the second path are used as the autonomous mobile device's movement path.

In the method provided in the embodiments of the present disclosure, by determining the first path from the first position to the region boundary of the operational map and the second path from the boundary to the second position, an boundary-following path can be obtained, This enables the autonomous mobile device to reach the second position by following the boundary-following path, thereby avoiding damaging the trimmed work area.

In at least one embodiment of the present disclosure, the autonomous mobile device may encounter obstacles (e.g., birds, animals, humans, vehicles, stones, trees, etc.) during cross-region operations along the movement path. If obstacles is detected on the movement path, an obstacle avoidance path can be generated to perform obstacle avoidance processing. FIG. 8 is a flowchart illustrating a method for determining an obstacle avoidance path, provided in an embodiment of the present disclosure. The obstacle avoidance path determination method is applied to the autonomous mobile device. As shown in FIG. 8, the method comprises the following steps:

S31, determining an avoidance path corresponding to obstacles based on the operational map, when the movement path includes the obstacles.

In at least one embodiment of the present disclosure, a preset sensor is provided on the autonomous mobile device to detect whether there are obstacles exists on the current movement path. The type of the preset sensor may be selected based on actual operational requirements. For example, the preset sensor may include, but is not limited to, a collision sensor, a depth sensor, an ultrasonic sensor, or an infrared sensor.

For example, the preset sensor may collect detection data in real time or at preset time intervals along the current movement path. By analyzing the detection data, it is possible to determine whether there are any obstacles exists on the movement path. The data type of the detection data may vary depending on the type of preset sensor. For instance, detection data collected by a collision sensor may be impact data; data collected by a depth sensor may be depth data; data collected by an ultrasonic sensor may be ultrasonic data; and data collected by an infrared sensor may be infrared data, among others.

In some embodiments, if no obstacle is detected along the movement path, the movement path is not adjusted, and the autonomous mobile device performs cross-area operations base the movement path, if there are obstacles along the movement path, an obstacle avoidance path is generated. In some embodiments, the determining the obstacle avoidance path corresponding to the obstacle may comprises: determining characteristic information of the obstacle; and based on the operational map, generating the obstacle avoidance path according to the characteristic information. The characteristic information of the obstacle may comprise the shape, contour, and position of the obstacle. By identifying the characteristic information of the obstacle and generating the obstacle avoidance path accordingly, the autonomous mobile device can fully bypass the obstacle, thereby improving the accuracy of obstacle avoidance path planning and ensuring operational safety. In one embodiment, the obstacle avoidance path may be a polyline composed of three line segments, allowing the autonomous mobile device to bypass the obstacle by following the polyline. In other embodiments, the obstacle avoidance path may be an arc, allowing the autonomous mobile device to bypass the obstacle by following the arc path. The shape of the obstacle avoidance path can be configured based on actual operational requirements and is not limited herein.

S32, adjusting the movement path based on the avoidance path.

In at least one embodiment of the present disclosure, the obstacle avoidance path includes an obstacle avoidance start point and an obstacle avoidance endpoint. Since the autonomous mobile device encounters the obstacles during movement along the movement path, the obstacle avoidance start point is typically located on the movement path, while the obstacle avoidance end point may be determined based on actual operational requirements. In one embodiment, both the obstacle avoidance starting point and the obstacle avoidance endpoint of the obstacle avoidance path can be located within the mobile path, such that the autonomous mobile device can resume operation along the movement path after bypassing the obstacle. In other embodiments, the obstacle avoidance end point is not located on the original movement path, enabling the autonomous mobile device to continue operating along the mobile path after avoiding the obstacle, enabling the autonomous mobile device to continue operating along the movement path after avoiding the obstacle, In other embodiments, the obstacle avoidance endpoint of the obstacle avoidance path is not located within the mobile path. After the autonomous mobile device bypasses the obstacle according to the obstacle avoidance path, the mobile path must be replanned from the obstacle avoidance end point to the second position.

Based on this, the method further comprises: if the obstacle avoidance endpoint is not located on the movement path, then, based on the operational map, the shortest path from the obstacle avoidance endpoint to the second position is determined as the adjusted movement path. For example, a straight-line path from the obstacle avoidance endpoint to the second position may be replanned within the operational map as the adjusted movement path (i.e., a non-boundary-following path). Alternatively, the adjusted movement path may be determined based on the obstacle avoidance endpoint, the region boundary of the operational map, and the second position (i.e., a boundary-following path). The method for planning the boundary-following path has been described in detail in steps S21 to S23 above and will not be repeated here.

In the path planning method provided in the embodiments of the present disclosure, when the obstacles are present in the movement path, an obstacle avoidance path is generated within the operational map based on the characteristic information of the obstacles. This improves both the efficiency and accuracy of obstacle avoidance path planning. Furthermore, the embodiments of the present disclosure perform obstacle avoidance planning based on an operational map obtained by merging the plurality of work areas, thereby avoiding the issue of clearing previously detected obstacles when each operation area is treated as an independent map for obstacle avoidance planning. thereby improving the operational safety of the autonomous mobile device is enhanced.

Please refer to FIG. 9, which is a structural diagram of the path planning device provided by the embodiment of this disclosure. In some embodiments, the path planning device 20 may include multiple functional modules composed of computer program segments. The computer programs of each program segment in the path planning device 20 may be stored in the memory of the mobile device and executed by at least one processor to perform the path planning function (as described in detail in FIG. 3).

In this embodiment, the path planning device 20 can be divided into multiple functional units based on the functions it performs. The functional units may comprise: a map determination unit 201, a map merging unit 202, and a path planning unit 203. The term “unit” as used herein refers to a series of computer program segments that can be executed by at least one processor and can perform a fixed function, which are stored in a memory. In this embodiment, the functions of each unit will be described in detail in subsequent embodiments.

The map determination unit is configured to acquire boundary maps corresponding to a plurality of work areas of the autonomous mobile device.

The map merging unit is configured to merge the boundary maps to obtain a operational map;

The path planning unit is configured to determine a movement path from a first position to a second position based on the first position and the second position in the operational map.

It can be understood that the path planning device 20 shares the same inventive concept as the above-described path planning method. The specific implementation of each module in the path planning device 20 corresponds to the steps of the path planning method described above. Therefore, the present application will not repeat those details here.

The above-described module division represents a logical functional partitioning, and other partitioning approaches may be adopted in actual implementation. Additionally, the functional modules in various embodiments of the present application may be integrated within the same processing unit, implemented as physically separate modules, or two or more modules may be integrated into the same unit. The integrated modules may be implemented in the form of hardware, or as a combination of hardware and software functional modules.

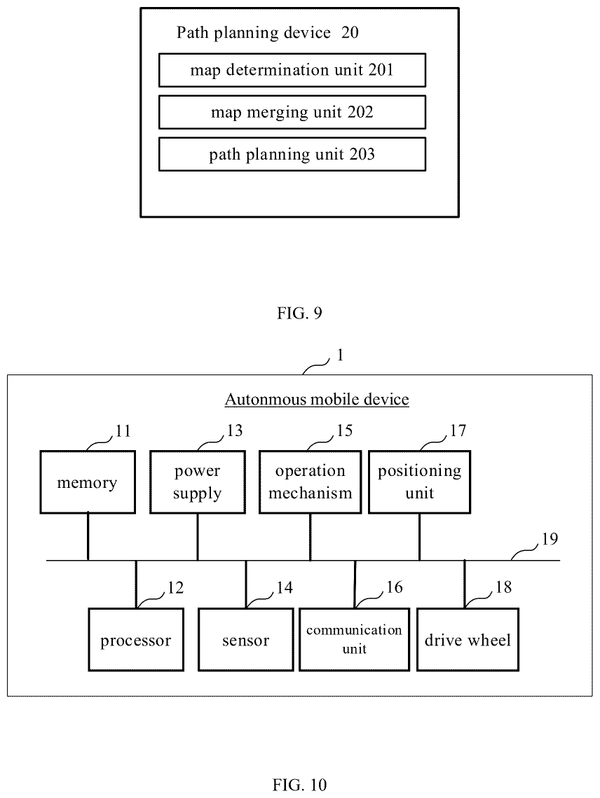

As shown in FIG. 10, this is a structural diagram of the autonomous mobile device provided by the embodiment of this disclosure. The autonomous mobile device 1 in FIG. 10 includes a main body and a memory 11, a processor 12, a power supply 13, a sensor 14, a operation mechanism 15, a communication unit 16, a positioning unit 17, a drive wheel 18, and a bus 19 installed on the main body. The processor 12 is coupled to the memory 11, power supply 13, sensor 14, operation mechanism 15, communication module 16, positioning module 17, and drive wheel 18 via the bus 19.

The memory 11 may include one or more random access memories (RAM) and one or more non-volatile memories (NVM). The RAM may be directly read from and written to by the processor 12 and may be used to store executable programs (e.g., machine instructions) of the operating system or other running applications, as well as user and application data. The RAM may include static random access memory (SRAM), dynamic random access memory (DRAM), synchronous dynamic random access memory (SDRAM), double data rate synchronous dynamic random access memory (DDR SDRAM), and others.

The non-transitory memory may also store executable programs and user/application data, which may be preloaded into the RAM for direct access and execution by the processor 12. The non-volatile memory may include disk storage devices and flash memory.

The memory 11 is configured to store one or more computer programs. These computer programs are configured to be executed by the processor 12. The programs include multiple instructions which, when executed by the processor 12, implement the path planning method performed by the autonomous mobile device 1.

In other embodiments, the autonomous mobile device 1 may further include an external memory interface for connecting to external memory, enabling the expansion of the storage capacity of the autonomous mobile device 1.

The processor 12 may include one or more processing units. For example, the processor 12 may comprise an application processor (AP), a modem processor, a graphics processing unit (GPU), an image signal processor (ISP), a controller, a video codec, a digital signal processor (DSP), a baseband processor, and/or a neural network processing unit (NPU). These various processing units may be implemented as separate components or integrated within one or more processor chips.

The processor 12 provides computing and control capabilities. For example, the processor 12 is configured to execute the computer programs stored in the memory 11 to implement the aforementioned path planning method.

The power supply 13 is configured to provide power to the autonomous mobile device. In one embodiment of the present application, the power supply 13 may include one or more types of power supply devices, such as a battery, fuel generator, solar power generation module, and wind power generation module.

The sensor 14 is configured to acquire information for the autonomous mobile device 1, such as environmental information and motion information of the device. In one embodiment of the present application, the sensor 14 may include one or more types of sensors, such as a LiDAR sensor, imaging device, infrared sensor, and encoder.

The operation mechanism 15 is configured to perform corresponding operation tasks, such as mowing, de-icing, patrolling, sweeping, and pesticide spraying. In some embodiments of the present application, the operation mechanism 15 may include a motor, transmission mechanism, and a blade disc, among other components. When the autonomous mobile device is a lawn mower, the motor may drive the blade disc to rotate via the transmission mechanism to perform the mowing function. The motor may also control the movement of the blades to adjust the cutting height and the mowing area.

The communication unit 16 is configured to enable communication between the autonomous mobile device and other devices. In one embodiment of the present application, the communication module 16 may interact with other devices based on wired and/or wireless communication. The wireless communication may include one or more communication methods such as Bluetooth, Wi-Fi, and Near Field Communication (NFC).

The positioning unit 17 is configured to determine the location of the autonomous mobile device. In some embodiments of the present application, the positioning unit 17 may include one or more types of positioning modules such as Global Positioning System (GPS), inertial navigation system, Real-Time Kinematic (RTK) carrier phase differential system, and the like.

The driving wheel 18 is configured to enable movement of the autonomous mobile device. In some embodiments of the present application, the driving wheel 18 may implement the movement function of the autonomous mobile device under the control of the processor 12. In some embodiments, the driving wheel 18 may include a left driving wheel and a right driving wheel.

The bus 19 at least provides communication channels for intercommunication among the memory 11, processor 12, power supply 13, sensor 14, operation mechanism 15, communication unit 16, positioning unit 17, and driving wheel 18 within the autonomous mobile device 1.

In other embodiments of the present disclosure, the autonomous mobile device 1 may further include a collision avoidance part and a steering assembly. The collision avoidance part is configured to prevent the driving wheel 18 from colliding with obstacles in front of the autonomous mobile device. The steering assembly is configured to adjust the travel direction of the driving wheel 18.

It is understood that the structure illustrated in the embodiments of the present application does not constitute a specific limitation on the autonomous mobile device 1. In other embodiments, the autonomous mobile device 1 may include more or fewer components than those shown, or may combine certain components, or split certain components, or arrange components differently. The illustrated components may be implemented in hardware, software, or a combination of software and hardware.

In the above embodiments, descriptions of each embodiment focus on different aspects, and parts not detailed or disclosed in a certain embodiment may refer to relevant descriptions in other embodiments.

Those skilled in the art will recognize that the units and algorithmic steps described in the examples of the embodiments disclosed herein can be implemented by electronic hardware, or by a combination of computer software and electronic hardware. Whether these functions are executed in hardware or software depends on the specific application and design constraints of the technical solution. Skilled professionals may employ different methods to realize the described functions for each specific disclosure; however, such implementations should not be regarded as departing from the scope of the present disclosure.

The above embodiments are intended only to illustrate the technical solutions of the present disclosure and not to limit them. Although the present disclosure has been described in detail with reference to the foregoing embodiments, it should be understood by those skilled in the art that modifications may be made to the technical solutions described in the embodiments, or equivalent substitutions may be made to some technical features therein; such modifications or substitutions do not depart from the essence of the corresponding technical solutions, and should be encompassed within the protection scope of the present disclosure.

What is claimed is:

1. A path planning method, performed by an autonomous mobile device, comprising,
acquiring boundary maps corresponding to a plurality of work areas of the autonomous mobile device;
merging the boundary maps to obtain a operational map;
determining a movement path from a first position to a second position based on the first position and the second position in the operational map.

2. The path planning method according to claim 1, wherein acquiring boundary maps corresponding to the plurality of working areas of the autonomous mobile device comprises:
acquiring a plurality of boundary contours in response to a user operation instructions;
determining the boundary maps corresponding to the plurality of work areas of the autonomous mobile device based on the plurality of work areas contours, wherein at least two of the work areas overlap.

3. The path planning method according to claim 1, wherein determining the movement path from the first position to the second position comprises:
determining the shortest path from the first position to the second position as the movement path based on the operational map.

4. The path planning method according to claim 1,
wherein determining the movement path from the first position to the second position comprises:
determining a first path from the first position to a region boundary of the operational map;
determining a second path from the boundary of the operational map to the second position; and
determining the movement path based on the first path and the second path.

5. The path planning method according to claim 4,
wherein the region boundary of the operational map comprises a plurality of boundary position points, and determining the first path and the second path comprises:
determining, from the plurality of boundary position points, a target boundary position point corresponding to a minimal working distance from the first position to the region boundary of the operational map;
determining a path from the first position to the target boundary position point as the first path; and
determining a shortest path from the target boundary position point to the second position as the second path.

6. The path planning method according to claim 5,
wherein determining the movement path based on the first path and the second path comprises:
moving from the first position to the target boundary position point according to the first path; and
moving from the target boundary position point to the second position according to the second path.

7. The path planning method according to claim 1, further comprising:
determining an avoidance path corresponding to obstacles based on the operational map, when the movement path includes the obstacles; and
adjusting the movement path based on the avoidance path.

8. The path planning method according to claim 7, wherein after determining the avoidance path corresponding to the obstacle based on the operational map, the method further comprises:
determining an avoidance endpoint corresponding to the avoidance path;
when the avoidance endpoint is not on the movement path, determining a shortest path from the avoidance endpoint to the second position as an adjusted movement path based on the operational map.

9. An autonomous mobile device,
comprising:
a power supply, the power supply being configured to provide power to the autonomous mobile device; a sensor, the sensor being configured to obtain the environment information and the motion information of the autonomous mobile device;
a operation mechanism 15 being configured to perform an operational task, the operation mechanism comprises a motor, transmission mechanism, and a blade disc;
a memory,
a processor, and
a computer program stored on the memory and executable by the processor, the processor implements the path planning method, wherein the path planning method comprises:
acquiring boundary maps corresponding to a plurality of work areas of the autonomous mobile device;
merging the boundary maps to obtain a operational map;
determining a movement path from a first position to a second position based on the first position and the second position in the operational map.

10. The autonomous mobile device according to claim 9, wherein responding to the plurality of working areas of the autonomous mobile device comprises:
acquiring a plurality of boundary contours in response to a user operation instructions;
determining the boundary maps corresponding to the plurality of work areas of the autonomous mobile device based on the plurality of work areas contours, wherein at least two of the work areas overlap.

11. The autonomous mobile device according to claim 9, wherein determining the movement path from the first position to the second position comprises:
determining the shortest path from the first position to the second position as the movement path based on the operational map.

12. The autonomous mobile device according to claim 9,
wherein determining the movement path from the first position to the second position comprises:
determining a first path from the first position to a region boundary of the operational map;
determining a second path from the boundary of the operational map to the second position; and
determining the movement path based on the first path and the second path.

13. The autonomous mobile device according to claim 12,
wherein the region boundary of the operational map comprises a plurality of boundary position points,
and determining the first path and the second path comprises:
determining, from the plurality of boundary position points, a target boundary position point corresponding to a minimal working distance from the first position to the region boundary of the operational map;
determining a path from the first position to the target boundary position point as the first path; and
determining a shortest path from the target boundary position point to the second position as the second path.

14. The autonomous mobile device according to claim 13,
wherein determining the movement path based on the first path and the second path comprises:
moving from the first position to the target boundary position point according to the first path; and
moving from the target boundary position point to the second position according to the second path.

15. The autonomous mobile device according to claim 9, further comprising:
determining an avoidance path corresponding to obstacles based on the operational map, when the movement path includes the obstacles; and
adjusting the movement path based on the avoidance path.

16. The autonomous mobile device according to claim 15, wherein after determining the avoidance path corresponding to the obstacle based on the operational map, the method further comprises:
determining an avoidance endpoint corresponding to the avoidance path;
when the avoidance endpoint is not on the movement path, determining a shortest path from the avoidance endpoint to the second position as an adjusted movement path based on the operational map.

17. A non-transitory computer-readable storage medium,
wherein the computer-readable storage medium stores a computer program,
when executed by a processor of an autonomous mobile device, the computer program implements the path planning method according to claim 1.
